(19) United States
(12) Patent Application Publication
(10) Pub. No.: US 2003/0151159 A1
(43) Pub. Date: Aug. 14, 2003

(54) Protective composite wrap

(76) Inventors: Jorge Santisteban, San Luis Potosi (MX); Juana Rocio Guajardo Torres, San Luis Potosi (MX)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/259,312

(22) Filed: Sep. 27, 2002

Related U.S. Application Data
(60) Provisional application No. 60/325,980, filed on Sep. 28, 2001.

(51) Int. Cl. B29C 67/00; B32B 7/12; B32B 15/04

(52) U.S. Cl. 264/136; 428/343

(57) ABSTRACT

A process of making a protective composite wrap, which exhibits the ability to protect metallic objects from corrosion environments, wherein a first thermoplastic resin and a vapor corrosion inhibitor are blended into a homogenous blend, wherein the homogenous blend is extruded into continuous thermoplastic filaments, which are collected into a nonwoven fabric, wherein a second thermoplastic resin is extruded into a continuous thin film, and wherein the nonwoven fabric and the thin film are affixed into a face to face juxtaposition to form the protective composite wrap.

### TECHNICAL FIELD

The present invention relates to a protective composite wrap for metallic objects comprising a nonwoven and a film layer, said nonwoven fabric containing an internal vapor corrosion inhibitor that serves to shield said metallic object from deleterious effects induced by a corrosive environment.

### BACKGROUND OF THE INVENTION

Nonwoven fabrics are those fabrics consisting of fibrous materials, such as synthetic or natural fibers or combinations thereof. These fibers are then interconnected to form a web or batt that can then be further treated in order to achieve a fabric with the desired physical properties. Nonwoven fabrics are particularly advantageous due to the high-rate of speed in which they can be manufactured while maintaining their similarities to woven fabrics. The present invention combines a nonwoven fabric with a film to produce a protective composite wrap for metallic objects. Further more, the composite includes a vapor corrosion inhibitor in order to provide the metallic object with lasting corrosion protection.

The incorporation of a vapor corrosion inhibitor into a metal wrap has proved to be beneficial. By adding a vapor corrosion inhibitor to the wrap, the metal is chemically protected from any damaging environmental elements. In prior U.S. Pat. Nos. 5,736,231 and 5,491,017, vapor corrosion inhibitors are included as a separate component of a nonwoven and film composite wrap, whereby the film is a shrink/stretch film. U.S. Pat. No. 5,736,231 discloses a material for protecting products in which a vapor corrosion inhibitor is housed within the adhesive that adheres the nonwoven to the film. U.S. Pat. No. 5,491,017 discloses a shrink-wrap which is made up of a nonwoven fabric and film, the nonwoven being treated topically with an additive which can be a chemical that controls the environment surrounding the protected article. In both cases the material is a shrink-wrap material whereby the film responds through contraction in the presence of heat. By using a shrink/stretch film, the film is rendered vulnerable when exposed to heat and can be subject to structural failure.

The present invention is a protective wrap composite, also known as a steel wrap, but should not be considered a “shrink-wrap” in that the wrap does not contract around an object. This protective wrap is beneficial in that it can easily provide protection for metallic objects of any size, including sheet metal, which would prove exceedingly difficult to wrap and evenly heat so as to uniformly contract a shrink-wrap type of material. The present invention fulfills a need for a protective metallic wrap composite that can be quickly applied to objects of varying size.

### SUMMARY OF THE INVENTION

The present invention relates to a protective composite wrap for metals comprising a nonwoven and a film layer, in which the nonwoven fabric contains an internal vapor corrosion inhibitor. In referring to the present invention, the vapor corrosion inhibitor (VCI) is incorporated into the fibers or filaments of the nonwoven fabric. The nonwoven fabric is a spunmelt, consisting of a meltblown or spunbond, and a combination thereof. The additive is introduced to the base resin as a melt additive and is extruded onto a foraminous belt where by the fibers or filaments are collected and bonded. Integrating the VCI additive with the polymer allows for a homogeneous mixture to be extruded and to be transformed into a more durable nonwoven fabric.

The melt-extruded VCI additive employed in the present invention is a morpholinic additive. The melt-additive may be compounded with the base resin in the range of about 0.1 to 5.0% by weight. The preferred range being from 0.1 to 3.0% by weight. The most preferred range being in the amount of 0.1 to 1.0% by weight. In the present invention, the most preferred morpholinic additives are those containing two morpholine groups that are bridged by oxygen and variable lengths of hydrocarbon chains, which may be represented by bis-morpholine, 4,4′-(oxydi-2, 1-ethanediyl).

In addition to a nonwoven with the above mentioned internal VCI additive, the present invention includes a barrier film layer. The barrier film can comprise thermoplastic resins, with the preferred thermoplastic being selected from the polyolefins: polyethylene, polypropylene, and the combinations thereof. The barrier film layer provides for two beneficial effects: to protect the nonwoven fabric from further damage due to environmental conditions (i.e. water vapor) and to control the evolution of the additive into a controlled environment between the film and the metallic object. The barrier film may be bonded to the nonwoven fabric by conventional means, such as adhesive, thermally, or by any other means of bonding known to those skilled in the art. The construction of this protective wrap composite is useful in protecting metallic objects, and specifically sheet steel, from corrosion.

The protective composite wrap is advantageous over commercially available shrink-wraps because it does not need to be heated or contracted in order to provide a metallic product with a noncorrosion environment. The protective composite wrap is intended for use in shielding various metals, and the alloys thereof, from deleterious environmental elements.

### BRIEF DESCRIPTION OF THE DRAWINGS

FIG. 1 is a view of the bi-layered protective composite wrap upon the outer surface of a metallic object.

### DETAILED DESCRIPTION OF THE INVENTION

While the present invention is susceptible of embodiment in various forms, hereinafter is described a presently preferred embodiment of the invention, with the understanding that the present disclosure is to be considered as an exemplification of the invention, and is not intended to limit the invention to the specific embodiment illustrated.

The vapor corrosion inhibitor of the present invention is a morpholine derivative. Morpholine is a cyclic amine with hygroscopic properties and is widely used as a corrosion inhibitor, especially in steam boiler systems. In the present invention the VCI additive was supplied by Techmer PM as a bis-morpholine, 4,4′-(oxydi-2, 1-ethanediyl), as is commercially available under the reference number S-122738E25.

It is believed the VCI additive works by migrating to the surface of the polymeric filament or fiber and into physical contact with the wrapped article. It is also believed the VCI additive can also volatilize into the environment surrounding the wrapped article to form a protective gaseous environment.

The VCI additive is blended into the nonwoven fibers or filaments of the nonwoven fabric, so as to have a controlled and uniform distribution. The additive is added to the base resin as a melt additive prior to extrusion in order to achieve proper homogeneity within the resultant fabric. The fibers or filaments of the present invention can be polyesters, polyamides, or polyolefins, such as polypropylene, polyethylene, and the combinations thereof The fibers or filaments may also be one of a multi-component configuration of the above mentioned polymers.

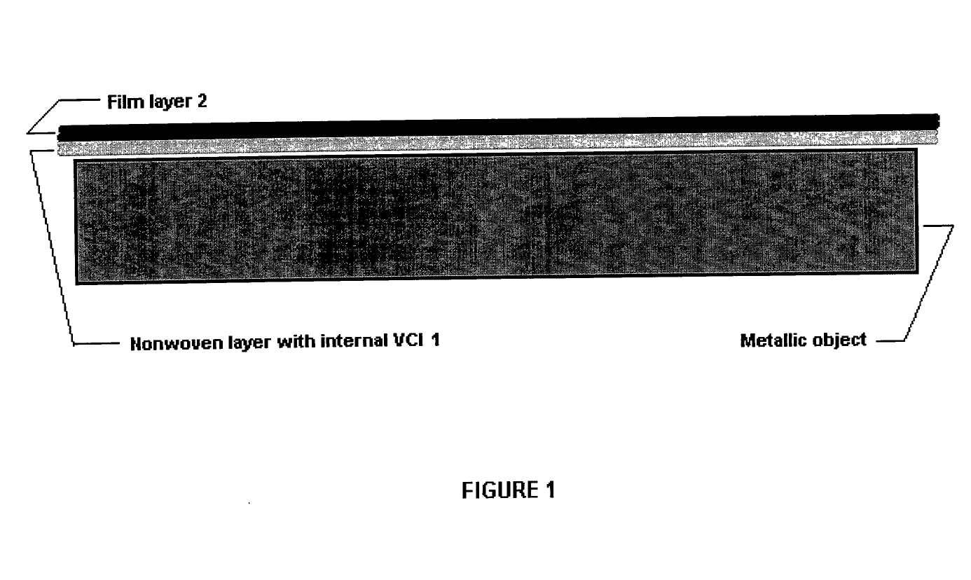

In reference to FIG. 1, the nonwoven fabric 1 of the present invention is a spunmelt nonwoven, as exemplified by meltblown fabrics or spunbond fabrics, and any combinations thereof.

A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs is collected upon the uppermost surface of the previously formed web. The web is then at least temporarily consolidated, usually by means involving heat and pressure, such as by thermal point bonding. Using this bonding means, the web or layers of webs are passed between two hot metal rolls, one of which has an embossed pattern to impart and achieve the desired degree of point bonding, usually on the order of 10 to 40 percent of the overall surface area being so bonded.

A related means to the spunbond process for forming a layer of a nonwoven fabric is the melt blown process. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll.

The nonwoven fabric in the present invention, as illustrated in FIG. 1, is covered with a film 2 which is intended to behave as an environmental-barrier. The continuous thin film is extruded onto the nonwoven substracted, but may also be affixed with adhesive, laminated, or by any other methods as is well known by those skilled in the art. The film 2 in the present invention may be selected from a group of polyolefins, polyesters, or other thermoplastics. The film ensures the VCI is emitted in only one direction and ensures a controlled atmosphere about the wrapped metallic object.

### EXAMPLE

This is one example of the present invention and is not meant to limit the present invention is any way.

A 17 mils thick spunbond polypropylene with a weight of 80 g/m² was internally treated with 0.8% by weight of bis-morpholine, 4,4′-(oxydi-2, 1-ethanediyl), a VCI melt-additive (Provided by Techmer PM, commercially available as S-122738E25). A polyethylene film 0.5 mils thick with a weight of 25 g/m² was laminated onto the spunbond polypropylene. This particular example was treated with a pigment to achieve a beige color. The following example was tested and evaluated.

Test Procedures

Grab Tensile Test (ASTM Test D5034-95)

This test is meant to measure the breaking strength of the fabric in units of either grams or pounds as well as measures the elongation of the fabric.

Accelerated Corrosion Tests (ASTM Test B-117)

Several accelerated corrosion tests may be applied to test the deterioration rate of a sample. Accelerated corrosion tests may necessitate that a sample endure exposure to an acidic and/or salt solution for specific time intervals. Results of oxidation percentages were evaluated under ASTM D-610-95.

Data Table

| Test Performed On Example | | |
|---|---|---|
| Described Above | Results | |
| Accelerated Corrosion | 0.3% | oxidation |
| Test (ASTM B-117) | (at all time intervals) | |
| Machine Direction | 70.5 | lbs/in |
| Grab Tensile (ASTM D5034-95) | | |
| Machine Direction | 39.8% | |
| Grab Elongation | | |
| Cross Direction | 50.6 | lbs/in |
| Grab Tensile | | |
| Cross Direction | 50.9% | |
| Grab Elongation | | |
| Basis Weight | 105 | gsm |
| Thickness (ASTM D-5729) | 17.8 | mils |

The test data for the protective composite wrap as per example 1, demonstrates an excellent corrosion inhibiting performance with only 0.3% oxidation for all three tested time intervals with a maximum time interval of 21 days. Testing the vapor corrosion inhibitor at such great time intervals prove to be significant for those metal objects that require an extensive length of time to be shipped. The strength of the nonwoven also proves to be significant, as it is imperative that the nonwoven be durable, strong, and yield with the application of force. The maintenance of the nonwovens integrity ensures that the wrapped article is properly being protected. Any degradation of the nonwoven allows for potential damage to the article.

What is claimed is:

1. A process of making a protective composite wrap, comprising:
a. providing a thermoplastic resin;
b. providing a vapor corrosion inhibitor;
c. blending said thermoplastic resin and said vapor corrosion inhibitor into a homogeneous blend;
d. extrude said homogeneous blend as continuous thermoplastic filaments;
e. collecting and consolidating said thermoplastic filaments into a nonwoven fabric; and
f. said nonwoven fabric exhibiting the ability to protect metallic objects from corrosion environments.

2. A process of making a protective composite wrap as in claim 1, wherein said thermoplastic resin is selected from the group consisting of polyamides, polyester, polyolefins, and the combinations thereof.

3. A process of making a protective composite wrap as in claim 2, wherein said polyolefin is polypropylene.

4. A process of making a protective composite wrap as in claim 1, wherein said is a morpholinic compound.

5. A process of making a protective composite wrap as in claim 4, wherein said morpholinic compound is bis-morpholine, 4,4′-(oxydi-2, 1-ethanediyl).

6. A process of making a protective composite wrap as in claim 1, wherein said continuous filaments are cut to a finite staple lengths.

7. A process of making a protective composite wrap as in claim 1, wherein said consolidating means is a thermal calendaring process.

8. A process of making a protective composite wrap, comprising:
a. providing a first thermoplastic resin;
b. providing a second thermoplastic resin;
c. providing a vapor corrosion inhibitor;
d. blending said first thermoplastic resin and said vapor corrosion inhibitor into a homogeneous blend;
e. extrude said homogeneous blend as continuous thermoplastic filaments;
f. collecting and consolidating said thermoplastic filaments into a nonwoven fabric;
g. extrude said second thermoplastic resin into a continuous thin film;
h. affix said nonwoven fabric and said continuous thin film into a face to face juxtaposition to form a protective composite wrap; and
i. said protective composite wrap exhibiting the ability to protect metallic objects from corrosion environments.

9. A process of making a protective composite wrap as in claim 8, wherein said second thermoplastic resin may be selected from a group of polyamides, polyesters, polyolefins, and combinations thereof.

10. A process of making a protective composite wrap as in claim 9, wherein said second thermoplastic resin is polyethylene.

11. A process of making a protective composite wrap as in claim 8, wherein said first thermoplastic resin is different then said second thermoplastic resin.

12. A process of making a protective composite wrap as in claim 8, wherein said continuous thin film is extruded directly upon the nonwoven fabric.

13. A protective composite wrap comprising a nonwoven fabric comprised of a thermoplastic resin and a vapor corrosion inhibitor present at a let down value of about 0.8% by weight, said nonwoven fabric having affixed thereto a continuous thin film to form a protective composite wrap, said protective composite wrap capable of protecting a metallic object from a corrosion environment in accordance with ASTM B-117 whereby said protective wrap is capable of protecting said metallic object at a maximum level of oxidation of no greater than 0.3% at a maximum time interval of 21 days.

14. A protective composite wrap as in claim 13, wherein said material is used in the fabrication of steel wrap.
